(19) United States
(12) Patent Application Publication
(10) Pub. No.: US 2013/0290818 A1
(43) Pub. Date: Oct. 31, 2013

(54) METHOD AND APPARATUS FOR SWITCHING BETWEEN PRESENTATIONS OF TWO MEDIA ITEMS

(71) Applicants: Juha Henrik Arrasvuori, Tampere (FI); Antti Johannes Eronen, Tampere (FI); Arto Juhani Lehtiniemi, Lempaala (FI)

(72) Inventors: Juha Henrik Arrasvuori, Tampere (FI); Antti Johannes Eronen, Tampere (FI); Arto Juhani Lehtiniemi, Lempaala (FI)

(73) Assignee: Nokia Corporation, Espoo (FI)

(21) Appl. No.: 13/458,243

(22) Filed: Apr. 27, 2012

(51) Int. Cl. G06F 17/00

(52) U.S. Cl. 715/201

(57) ABSTRACT

An approach is provided for switching between presentations of two media items. A media platform determines a request to cause, at least in part, a switching of a presentation of a first media item to a second media item. The media platform processes and/or facilitates a processing of metadata associated with the first media item, the second media item, or a combination thereof to cause, at least in part, a synthesis of one or more transitions. The media platform causes, at least in part, a presentation of the one or more transitions during the switching.

### BACKGROUND

Service providers and device manufacturers (e.g., wireless, cellular, etc.) are continually challenged to deliver value and convenience to consumers by, for example, providing compelling network services. The amount of content accessible by devices through the network services is increasing. However, no services currently exist that allow a user to control transitions when switching of media items, media channels, etc., during downloading (e.g., streaming, podcasting, etc.). Therefore, service providers and device manufacturers face significant technical challenges in providing a service that allows users to control such transitions based on, for example, user preferences, metadata of the media items/channels, as well as other characteristics associated with the media items/channels.

### SOME EXAMPLE EMBODIMENTS

Therefore, there is a need for an approach for switching between presentations of two media items.

According to one embodiment, a method comprises determining a request to cause, at least in part, a switching of a presentation of a first media item to a second media item. The method also comprises processing and/or facilitating a processing of metadata associated with the first media item, the second media item, or a combination thereof to cause, at least in part, a synthesis of one or more transitions. The method further comprises causing, at least in part, a presentation of the one or more transitions during the switching.

According to another embodiment, an apparatus comprises at least one processor, and at least one memory including computer program code for one or more computer programs, the at least one memory and the computer program code configured to, with the at least one processor, cause, at least in part, the apparatus to determine a request to cause, at least in part, a switching of a presentation of a first media item to a second media item. The apparatus is also caused to process and/or facilitate a processing of metadata associated with the first media item, the second media item, or a combination thereof to cause, at least in part, a synthesis of one or more transitions. The apparatus is further caused to cause, at least in part, a presentation of the one or more transitions during the switching.

According to another embodiment, a computer-readable storage medium carries one or more sequences of one or more instructions which, when executed by one or more processors, cause, at least in part, an apparatus to determine a request to cause, at least in part, a switching of a presentation of a first media item to a second media item. The apparatus is also caused to process and/or facilitate a processing of metadata associated with the first media item, the second media item, or a combination thereof to cause, at least in part, a synthesis of one or more transitions. The apparatus is further caused to cause, at least in part, a presentation of the one or more transitions during the switching.

According to another embodiment, an apparatus comprises means for determining a request to cause, at least in part, a switching of a presentation of a first media item to a second media item. The apparatus also comprises means for processing and/or facilitating a processing of metadata associated with the first media item, the second media item, or a combination thereof to cause, at least in part, a synthesis of one or more transitions. The apparatus further comprises means for causing, at least in part, a presentation of the one or more transitions during the switching.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of supporting switching between presentations of two media items, according to one example embodiment;

FIGS. 2A and 2B are diagrams of the components of a media platform and a user interface client, respectively, according to one example embodiment;

FIG. 3 is a flowchart of a process for switching between presentations of two media items, according to one example embodiment;

FIGS. 4A-4C are diagrams of a user interface utilized in the process of FIG. 3, according to various example embodiments;

FIG. 5A shows a musical transition generated between a song currently played in a first user device and a song going to be played in a second user device, according to one embodiment;

FIG. 5B shows a spatial transition generated between a music video currently played in a first user device and a music video to be played in a second user device, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for switching between presentations of two media items are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, structures and devices are shown in block diagram form in order to avoid unnecessarily obscuring the embodiments of the invention.

As used herein, the term “media item” refers to any type of media items that may include, for example, one or more songs, one or more fragments or portions of songs, one or more playlists, one or more voice recordings (e.g., speeches, seminars, conferences, radio talk shows, books on tapes, DJ's narratives, etc.), one or more fragments or portions of voice recordings, one or more images, one or more fragments or portions of images, one or more animated images, one or more fragments or portions of animated images, one or more videos, one or more fragments or portions of videos, or a combination thereof, where the media item may be two-dimensional, three-dimensional, or a combination thereof. Although various embodiments are described with respect to images and videos, it is contemplated that the approach described herein may be used with other type of media items that can be indexed according to one or more characteristics associated with the media items.

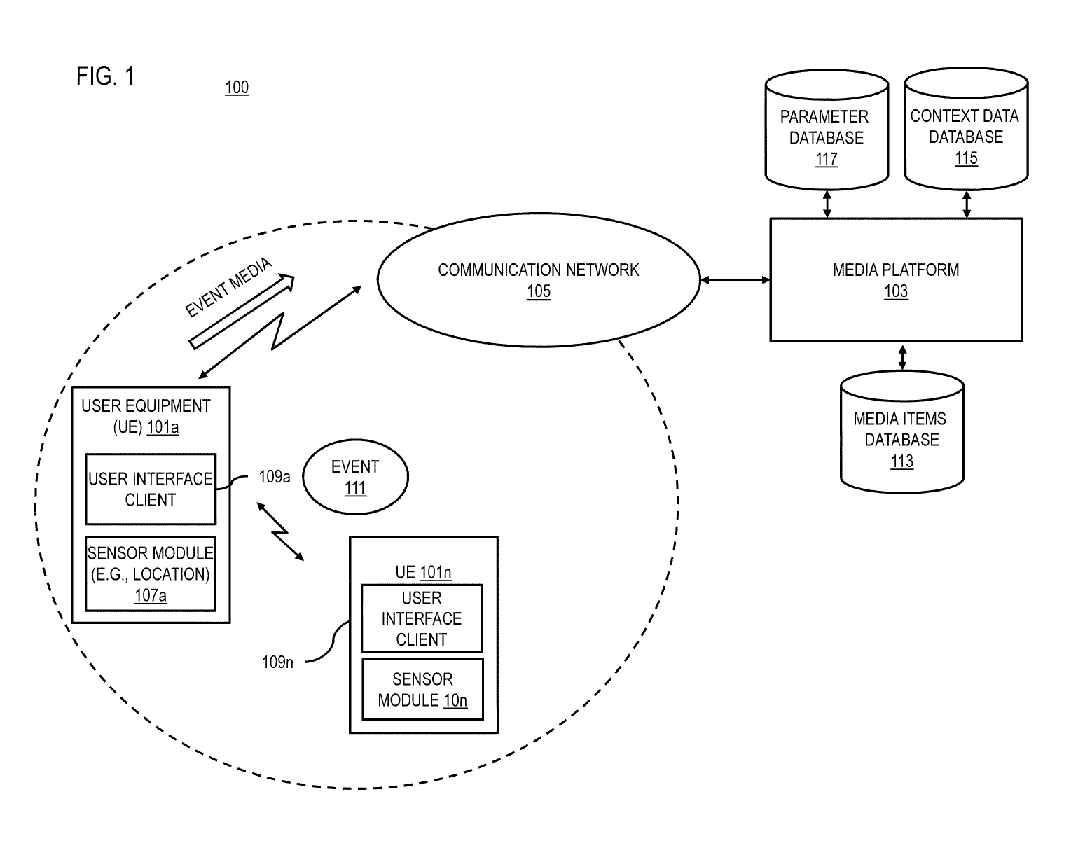

FIG. 1 is a diagram of a system capable of supporting switching between presentations of two media items, according to one example embodiment of the invention. As discussed above, the popularity of webcast, podcast, and user-generated content have exponentially increased the amount of media content that is accessible through various service providers and the Internet. More users now download media files (e.g., video, audio, images, etc.) using one or more web feeds, podcast channels, social network services platforms (e.g., MYSPACE®, YOUTUBE®, etc.), etc. However, the developments associated with media services and platforms have not supported the users to control transitions when switching of media items, media channels, etc., during downloading.

To address this problem, a system 100 of FIG. 1 introduces the capability to support remote switching between presentations of two media items. According to one example embodiment, the system 100 provides a user interface for a user to select a style, a format, a length, etc. of a transition to be presented between two media streams to prevent delay and silence in-between and to provide pleasant user experience. By way of example, the user requests to download a new music stream and a transition in-between, and selects a style of drum sounds. The drum sounds may be stored locally on the user device or on a media platform. The system 100 retrieves the metadata of the current media item and/or analyzes the tempo, beat, bar, key, rhythm, pitch chords, the dominant melody and bass line, etc. of the current media item. The metadata may include characteristics of the media item, such as the music genre, the lyrics and/or keywords from the lyrics, time signature, mood (danceable, romantic), ranking, reviews, etc.

Continuing with the example, the system 100 synthesizes a drum loop based on the metadata and/or the analysis. The Musical Instrument Digital Interface (MIDI) or other music description languages can be used to synthesize the drum loop. The system 100 then cross-fades between the current media item and the synthesized drum loop. Meanwhile, the system 100 requests information of the properties/metadata of the new media item in the new media stream, such as its initial tempo. The synthesized drum loop is playing on the user device while the user device is downloading the new media item and the requested information/metadata of the new media item. The system 100 estimates how long the time period the synthesized drum loop should be played based upon the metadata, such as tempo, genre, and/or used instruments, etc., of the new media item and/or a portion of the new media item, the downloading capabilities of the user device, the communication bandwidth for downloading the new media item and/or downloading the portion of the new media item, the communication network traffic, a size of data of the new media item/stream that has to be buffered on the user device before playback, etc., or a combination thereof. The system 100 then estimates when the user device can start to play the new media item. By way of example, one or two musical bars before playing the new media item, the system 100 starts synthesizing another drum loop to a tempo and rhythm that matches the beginning of the new media item, and then makes a cross-fade between the other drum loop and the second media item, and begins to play the second media item thereafter.

Many matching methods can be used to synchronize the drum loop and the beats of the first and second media items. For example, the presentation would sound like a drummer performs a “fill” as a transition between the two media items.

Alternatively, or in addition to the foregoing, the user may select a new media item in a different media channel for performing a switching process. The system 100, one or more media platforms, or a combination thereof, may support a user to listen to free or fee channels (e.g., of song playlists). In one embodiment, the music is streamed to the user device. In another embodiment, song files are downloaded to the user device for playback online and/or offline. By way of example, in response to a user request to a new media item in a different media channel, the system 100 reads the current media item in the current channel and the first media item in the new channel. The system 100 retrieves and/or extracts from the media stream/file metadata of the tempo, beat, bar, key, rhythm, pitch chords, and/or the dominant melody and bass line, etc. of the current media item and the next media item. The system 100 obtains a style of the transition, for example, based upon default settings, a user selection, analysis of user preference, etc. The transition can be in a style defined by the system 100, the user, one or more media service platforms, or a combination thereof. The system 100 can render some style options on a user interface (UI) of a player application residing in the user device. For example, an “aggressive style” would generate transitions with dense snare drum beats and distorted guitar sounds. As another example, an “80's style” would generate transitions using synthetic instrument sounds that were popular in the 80's. The user may define a new transition style based upon desired timing, duration, tempo, beat, bar, key, rhythm, pitch chords, and/or the dominant melody and bass line, etc. Alternatively, the user may define the desired timing, duration, tempo, beats, etc. of the transition, without creating a new style or indicating an existing style.

In one embodiment, the system 100 generates a transition of two songs based upon a style to provide a smooth/pleasing transition of at least one of the tempos, beats, bars, keys, etc. of the songs. The system 100 aligns timings and mixing points of the transition such that a beginning of the transition has at least one of tempo, beats, down beats, etc. match with at least one of tempo, beats, down beats, etc. of the current song, and an end of the transition has at least one of tempo, beats, down beats, etc. match with at least one of tempo, beats, down beats, etc. of the next song. The system 100 then renders the transition between the current and next songs at the mixing points and the timings.

In one embodiment, the system 100 receives a user request to cause a switching of a presentation of a first media item to a second media item. The system 100 may start the switching process immediately upon the user request or at a set time point, a set point (e.g., a particular beat or key pattern, etc.) of the current media item, etc.

In one embodiment, the system 100 processes metadata associated with the first media item, the second media item, or a combination thereof to cause a synthesis of one or more transitions. The system 100 presents the one or more transitions during the switching. The one or more transitions include one or more musical transitions, one or more vocal transitions (e.g., via speech or singing synthesis), one or more visual transitions (e.g., via visualizing music playing in the two songs and/or channels), or a combination thereof.

A musical transition may be generated by analyzing or otherwise obtaining metadata of the current song and the next song, pre-accessing the song in the next channel and generating a transition between the songs. By way of example, the system 100 analyzes the current song, pre-accesses and analyzes the next song, and generates a transition between the songs.

A vocal transition may be generated by speech or singing synthesis, such as text-to-speech to announce the next song and artist in the playlist, text-to-singing synthesis, etc. By way of example, the system 100 retrieves one or more voice recordings of the user, the user's contact, celebrities (e.g., Dr. Martin Luther King, a US Presidential candidate, Warren Buffett, Steve Jobs, etc.), etc. to generate a vocal transition. The information of the voice recordings may be obtained from the metadata thereof to match with the metadata of the two songs and/or the name of a new channel. In another embodiment, the user says the title and artist of the next song, and the system 100 makes the recording into a vocal recording. Other content information (e.g., news, weather, traffic, concerts, shows/events/activities, advertisements, public announcements, etc.) may be recorded and/or vocalized to be included in the vocal transition. Examples of shows/events/activities include sports competitions, concerts, cultural events, product releases, fashion shows, trade shows, conventions, festivals, parties, ceremonies, disasters, and the like.

A visual transition may be generated by visualizing music playing in the two songs and/or channels. In one embodiment, the system 100 visualizes the current and next songs, blends elements from the two song visualization in synchrony with the music, and generates a transition between the songs. Depending on one or more attributes (e.g., genre), the system 100 makes the visual transition match the current song and the next song. For example, the visual transition includes a ‘classical looking’ element (e.g., Beethoven portrait) for the currently played classical music, as well as a meditation element (e.g., early spring) for the coming new age music. The early spring element may contain dynamically changing spring colors.

Further, the user may input or select characteristics associated with the current and/or next media items, such as an artist of the media items, and may select additional one or more characteristics associated with the media items, such as sudden changes of tempo, beats, pitches, rhythms, sound/lighting volumes (e.g., climax of the media, etc.), time of day, season, orientation, depth of field, white balance, author(s), etc., for generating the transition. In another embodiment, the system 100 suggests characteristics associated with the media segments/items, characteristics associated with the media channels, or a combination thereof for the user to select for generating the transition. By way of example, the system 100 retrieves metadata of the current and the next media items, presents some or all of the metadata on a user interface as options for the user to select, and then generates a personalized transition accordingly.

Alternatively, or in addition to the foregoing, the system 100 calculates one or more quantity representations of tempo, beats, pitches, rhythms, chromagram, sound/lighting volumes (e.g., climax of the media, etc.), etc., and/or their respective changes of the media items, and recommends/displays to the user mixing points for the transition with the beginning and end regions of each media items.

In one embodiment, the system 100 displays on a user interface the one or more quantity representations of tempo, beats, pitches, rhythms, chromagram, sound/lighting volumes (e.g., climax of the media, etc.), etc., and/or their respective changes, and the mixing points for the transition. In another embodiment, the user can sample (e.g., listen, view, etc.) some or all portions of the quantified representations. In yet another embodiment, the user can slide the mixing points on the user interface to preview the transitional effects.

In one embodiment, the system 100 recommends mixing points for the transition such that they share similar musical, vocal, visual properties. By way of example, the system 100 mixes two songs by aligning their beats, keys, etc. In another one embodiment, the system 100 recommends mixing points for the transition such that they have different musical, vocal, visual properties to match with a style, mood, etc. associated with the user, the media items, etc. By way of example, the chosen style is horror yet warm. The system 100 selects a transition including human screaming and animal howling to go in-between a Halloween carton and a birthday video clip, and the system 100 further selects an absurd/surprising mixing point between the human screaming and the a Halloween carton.

In one embodiment, the system 100 estimates how long the transition should be based upon the metadata of the new media item and/or a portion of the new media item, the downloading capabilities of the user device, the communication bandwidth for downloading the metadata of the new media item and/or downloading the portion of the new media item, the communication network traffic, a size of data of the new media item/stream that has to be buffered on the user device before playback, etc., or a combination thereof. The system 100 then estimates when the user device can start playing the new media item.

In one embodiment, the system 100 offers an option of cross-fading between the transition and the currently played media item, the next media item, or a combination thereof. Cross-fading involves decreasing the volume of a currently played song or the audio portion of a media item, and increasing the volume of the next song or the audio portion of the next media item at the same time.

In one embodiment, the system 100 offers the user a one-touch capability such that the transition generation, playback of the transition and media items, etc. for switching between two media items/channels are automatically completed after the user's selection of a new media item/channel, or after a user's selection of “Find me a new Media item/channel”, etc. The system 100 may find such a new media item/channel based, at least in part, on user information, media consumption history, user preferences, user group preferences, user context (e.g., time, locations, events), etc.

Typical user information elements include a user identifier (e.g., telephone number), user device model (e.g., to identify device capabilities), age, nationality, language preferences, interest areas, login credentials (to access the listed information resources of external links). In one embodiment, the preference data is automatically retrieved and/or generated by the system 100 from external sources. In another embodiment, the preference information is recorded at the user device based upon user personal data, online interactions and related activities with respect to specific topics, points of interests, or locations, etc.

The context information refers to discrete context characteristics/data of a user and/or the user device, such as a date, time, location (e.g., points of interest), current event/activity, weather, a history of activities, etc. associated with the user. The possibilities for the user to show up at a cell/POI and to request for location based services can be discovered via, for instance, data-mining or other querying processes. In particular, the contextual data elements may include location (where the user/UE is available, wherein the location based services is applicable, etc.), activity dates (the range of dates for which the user/UE and/or the location based services is available), event type (event information associated with the user/UE), time (of the event if the user/UE involves), applicable context (in which the location based services is applicable), and user preference information, etc.

In one embodiment, the system 100 provides an interface for users to collaboratively select songs for a playlist and create musical transitions, where there are multiple devices present (e.g., in a party setting). By way of example, each collaborating device at the party plays music in turn as the “DJ of the party,” generates a musical transition, and passes the control to the next device by flicking the device in the direction of the next user. The musical transition may be spatial as a visual representation of the control, the media item, and/or transition moving from one device to another.

In some embodiments, the system 100 personalizes the music transition experience via different user interface interactions, such as dragging and dropping a new media item/channel on top of a current media item/channel to trigger a transition, using a user drag-and-drop gesture distance and/or the overlap of the media items to control the length of a transition, hovering over a new media item/channel for a normal, musical, vocal, or visual transition, hovering over a new media item/channel for preview and/or switch, manipulating aggressiveness of interaction with the representation of a new media item/channel to control the length of transition or for defining a transition style or the user's mood, etc.

As shown in FIG. 1, the system 100 comprises one or more user equipment (UEs) 101a-101n (also collectively referred to as the UEs 101) containing a user interface client 109a-109n (also collectively referred to as user interface client 109) having connectivity to a media platform 103 via a communication network 105. In one example embodiment, the UEs 101 are used to present media items/files (e.g., videos, photos, audio, etc.) at an event 111 (e.g., a party). In one example embodiment, the UEs 101 are used to capture and then transmit the plurality of media items taken by different user devices with related information (e.g., context data and/or metadata) to the media platform 103 for further processing and/or storage in the media items database 113 and the context data database 115, respectively.

In another embodiment, for instance, user preference and contextual information to be processed by the media platform 103 may reside and remain at the UE 101. Thus, where the UE 101 is a mobile device, such an embodiment may reduce the resource consumption of, for example, the battery, by avoiding transmitting the user preference and contextual information over the communication network 105. Such an embodiment may also reduce privacy issues by maintaining private information at the UE 101 without transmitting the private information over the communication network 105. In yet another embodiment, the media platform 103 may be embodied in one or more services on a service platform.

The user interface client 109 may perform all or some of the functions of the media platform 103 such that the functions (e.g., generating transitions in-between two media items during downloading) of the media platform 103 are embodied in the user interface client 109. In some embodiments, the user interface client 109 enables the UE 101 to interact with, for instance, the media platform 103 to perform all or some of the functions of the media platform 103.

In one embodiment, the user interface client 109 of the UEs 101 and media platform 103 interact according to a client-server model to present and/or playback a transition in-between two media items. In one embodiment, the UEs 101 may include a sensor module 107a-107n (also collectively referred to as sensor modules 107) to determine context data associated with the plurality of media items (e.g., location information, timing information, orientation, etc.). The sensor modules 107 may be utilized by one or more applications (not shown for illustrative purposes) to capture and/or present media of an event 111. In one embodiment, the user interface client 109 renders at the user interface of the UEs 101 videos with a transition based upon location information (e.g., at the party) associated with the videos determined from the sensor modules 107. In addition, the user interface client 109 renders the user interface of the UEs 101 based on the ability to use the UEs to multiplex the videos. If the UEs 101 includes a three-dimensional display screen, the user interface client 109 can also render the user interface of the UEs 101 as an object with the respective one or more user interface elements for media switching, such as styles, moods, tempo, beat, bar, key, rhythm, pitch chords, the dominant melody and bass line, timings, lengths, etc. In response to a user switching request, the user interface client 109 and/or the media platform 103 can then determine to generate one or more transitions for switching between two media item/channel as requested by a user.

In one example embodiment, the media items may be user-generated or commercially generated, advertisements, or a combination thereof. When the plurality of media items is captured by the UEs 101, related context data (e.g., metadata) is also simultaneously generated for example from the sensor modules 107 within the UEs 101 and the context data can then be determined and associated with the plurality of media items by the media platform 103 or by the UEs 101 themselves. By way of example, the context data associated with the plurality of media items can include time information, a position of the UEs 101, an altitude of the UEs 101, a tilt of the UEs 101, an orientation/angle of the UEs 101, a zoom level of the camera lens of the UEs 101, a focal length of the camera lens of the UEs 101, a field of view of the camera lens of the UEs 101, a radius of interest of the UEs 101 while capturing the media content, a range of interest of the UEs 101 while capturing the media content, tempo, beat, bar, key, rhythm, pitch chords, the dominant melody and bass line, comments/notes entered by the user, or a combination thereof. The position of the UEs 101 can be also be detected from one or more sensors of the UE 101 (e.g., via GPS). The user's location can be determined by Cell of Origin, wireless local area network triangulation, or other location extrapolation technologies. Further, the altitude can be detected from one or more sensors such as an altimeter and/or GPS. The tilt of the UEs 101 can be based on a reference point (e.g., a camera sensor location) with respect to the ground based on accelerometer information. Moreover, the orientation can be based on compass (e.g., magnetometer) information and may be based on a reference to north. One or more zoom levels, a focal length, and a field of view can be determined according to a camera sensor. Further, the radius of interest and/or focus can be determined based on one or more of the other parameters contained in parameter database 117 or another sensor (e.g., a range detection sensor). One or more tempo, beat, bar, key, rhythm, pitch chords, and/or the dominant melody and bass line, etc. can be determined based on one or more of the other parameters contained in parameter database 117 or signal processing algorithms which process music signals to extract these parameters. For example, known methods of music analysis may be used to analyze the melody, bass line, and/or chords in music. Such methods may be based on, for example, using frame-wise pitch-salience estimates as features. These features may be processed by an acoustic model for note events and musicological modeling of note transitions. The musicological model may involve key estimation and note bigrams which determine probabilities for transitions between target notes. A transcription of a melody or a bass line may be obtained using Viterbi search via the acoustic model. Furthermore, as known in prior art, chord estimation may be accomplished, for example, by training a number of chord profiles using pitch chroma features, and then comparing the extracted pitch chroma features against the chord profiles and selecting the chord based on the profile which best matches the extracted chroma features. Furthermore, known methods for beat, tempo, and downbeat analysis may be used to determine rhythmic aspects of music. Such methods may be based on, for example, measuring the degree of musical change or accent as a function of time from the music signal, and finding the most common or strongest periodicity from the accent signal to determine the music tempo. Such a determination might be performed, for example, using k-nearest neighbor regression and a database of songs with labeled tempi. Furthermore, music beats might be obtained by inputting the tempo value and the accent signal into a dynamic programming routine, which would track the most likely sequence of beats which maximally matches the peaks in the accent signal with the approximate period of adjacent beats matching the tempo. Furthermore, downbeats might be analyzed by correlating an accent signal having several frequency bands (e.g., low, middle, high) with a rhythmic template representing typical patterns of accentuation on different beats of a measure (the downbeat, the second beat, the third beat, the fourth beat), and selecting the downbeats as the beats where the template best matches the accent signal.

In one embodiment, the media platform 103 may receive the plurality of media items (e.g., videos, songs, etc.) and context data associated with the media items from the UEs 101 and other media platforms, content services, etc., and then buffer the information in the media items database 113 and the context data database 115, respectively. Alternatively, the context data can be buffered as a part of the respective media items. The media items database 113 can be utilized for collecting and buffering the plurality of media items. More specifically, the media items database 113 may include a plurality of media items and transitions generated by the system 100. Further, the context data database 115 may be utilized to store current and historical data about one or more events, and which media items belong to which event, and media channels. Moreover, the media platform 103 may have access to additional data (e.g., historical sensor data or additional historical information about a region that may or may not be associated with events) to determine if an event is occurring or has occurred at a particular time. This feature can be useful in determining if newly uploaded media items can be associated with one or more events. In one embodiment, the media platform 103 also determines one or more parameters associated with generating, synchronizing, presenting one or more transitions from the one or more parameters (e.g., timing, length, tempo, beat, bar, key, rhythm, pitch chords, the dominant melody and bass line, etc. of a media item) stored in the parameter database 117. More specifically, the media platform 103, in connection with the user interface client 109, can utilize the one or more parameters stored in the parameter database 117 to generate one or more customized/personalized transitions between media items/channels. The media items database 113, the context data database 115, and/or the parameter database 117 may exist in whole or part within the media platform 103, or independently.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), Near Field Communication (NFC) network, and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, mobile communication device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

By way of example, the UEs 101 and the media platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the user interface client 109 of the UEs 101 and the media platform 103 interact according to a client-server model. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to multiple processes on multiple hosts (sometimes called tiers) for reasons that include reliability, scalability, and redundancy, among others.

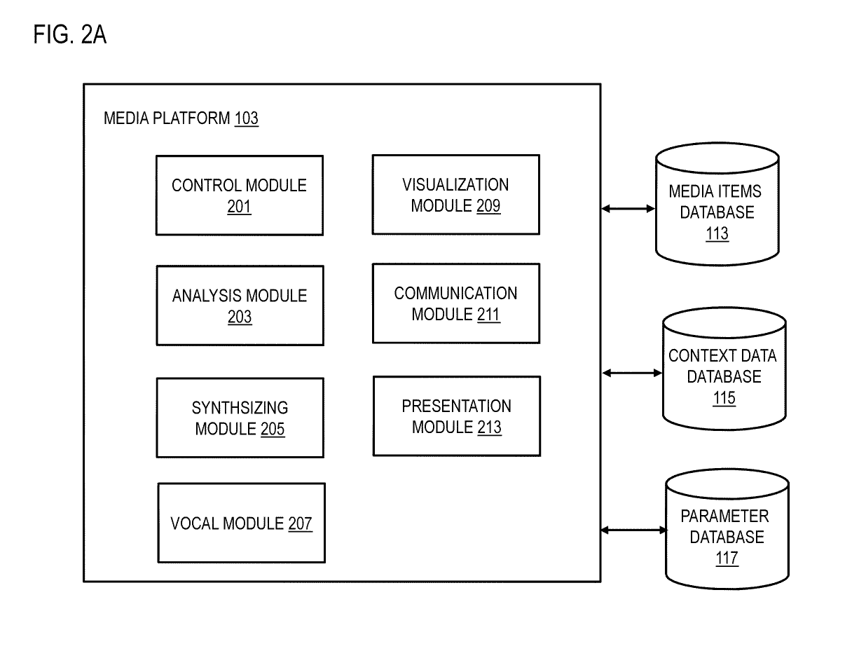

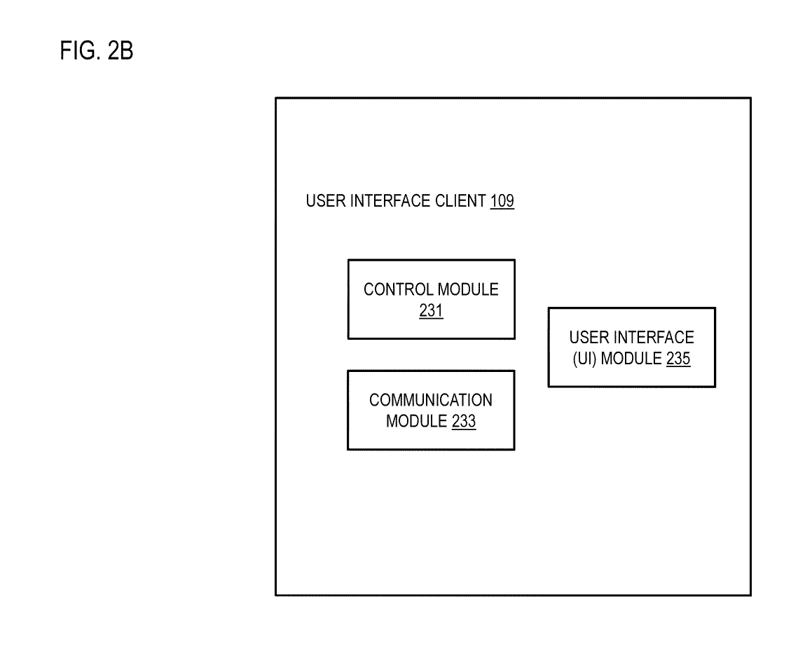

FIG. 2A is a diagram of the components of a media platform 103, according to one example embodiment of the invention. By way of example, the media platform 103 includes one or more server side components for providing generation of personalized transition between two media items. It is contemplated that the functions of these components may be combined in one or more components or performed by other components of equivalent functionality. In this embodiment, the media platform 103 includes a control module 201, an analysis module 203, a synthesizing module 205, a vocal module 207, a visualization module 209, a communication module 211, and a presentation module 213.

The control module 201 executes at least one algorithm for executing functions of the media platform 103. For example, the control module 201 may execute an algorithm for processing a request from a UE 101 (e.g., a mobile phone) to download a new media item (e.g., a video) while downloading a current media item. By way of another example, the control module 201 may execute an algorithm to interact with the analysis module 203 to determine the context or situation of the user (e.g., mood) and/or the UEs 101 (e.g., metadata or the media items including location, orientation, timing, etc.). The control module 201 may also execute an algorithm to interact with the analysis module 203 match/select the next media item based upon user indicated criteria (e.g., timing, user preferences, context characteristics, content characteristics, etc.).

The control module 201 may also execute an algorithm to interact with the synthesizing module 205, the vocal module 207, and/or a visualization module 209 to synthesize a normal music, vocal, or visualized transition between the two media items. The control module 201 may also execute an algorithm to interact with the communication module 211 to communicate among the media platform 103, the UEs 101 including the sensor modules 107 and the one or more applications (not shown for illustrative purposes), the media items database 113, the context data database 115, and the parameter database 117. The control module 201 also may execute an algorithm to interact with the presentation module 213 to switching the presentation to a new media item. The control module 201 also may execute an algorithm to interact with the user interface client 109 to cause the user interface client 109 to render a user interface for presenting the transition in-between two media items on a device based on one or more parameters (e.g., timing, length, tempo, beat, bar, key, rhythm, pitch chords, the dominant melody and bass line, etc.) selected by the user. The control module 201 also may execute an algorithm to interact with the user interface client 109 to cause the user interface client 109 to render a user interface for presenting the transition two-dimensionally and/or three-dimensionally, bead upon the user device display capabilities (e.g., a mobile device, a pico projector, or a combination thereof).

In one embodiment, the analysis module 203 may determine context data (e.g., metadata) by extracting the metadata embedded in a media channel or a file. In another embodiment, in case that metadata is not available or in an unknown format, the analysis module 203 may determine context data from built-in sensors associated with the personal recording devices (e.g., a mobile phone, a camcorder, a digital camera, etc.) used by one or more users to capture the plurality of media items (e.g., videos) of an event (e.g., a concert) and then uploaded to one or more databases. By way of example, the context data can be generated by one or more sensors built-in to the personal recording devices (e.g., an orientation sensor, an accelerometer, a timing sensor, GPS, etc.). More specifically, the context data associated with the media can include information related to the capture of the plurality of media items such as time, position, altitude, tilt, orientation, zoom, focal length, field of view, radius of interest, range of interest, tempo, beat, bar, key, rhythm, pitch chords, the dominant melody and bass line, or a combination thereof. The analysis module 203 may be used to determine an object of interest (e.g., an impressionism painting, another guest, etc.) for an event (e.g., a party) based upon a focus point (e.g., orientation) of the user device. Such an object of interest may be used to determine a style, a mood, etc. for generating a transition between two media items. Such an object of interest may be used to generate a visual transition between two media items.

“Styles” are different configurations for generating transitions. For example, “aggressive style” would generate transitions with dense snare drum beats and distorted guitar sounds. 80's style would generate transitions using synthetic instrument sounds that were popular in the 80's, etc. In one embodiment, some of these styles would be pre-made by famous or well-known artists. The transition styles may be used for free of fees (per use or subscription, etc.). “Mood” is a parameter that helps the synthesizing module 205 to select the next media item/channel for the user. By way of example, the user has defined his current mood as e.g., “aggressive” so the synthesizing module 205 selects only songs or channels that match this mood. The new channel could be selected based on user's mood, or the user's mood could be detected based, at least in part, on the next channel selected by the user. In another embodiment, the user uses a distance between fingers hovering on top of the user interface as input to indicate his mood to the analysis module 203. In yet another embodiment, the user defines the mood by selecting or capturing an image, i.e., image-defined mood”. In this embodiment, the analysis module 203 analyzes the image and defines a keyword for the user's mood.

The control module 201 may also execute an algorithm to interact with the communication module 211 to communicate among the media platform 103, the UEs 101 including the sensor modules 107 and the one or more applications (not shown for illustrative purposes), the media items database 113, the context data database 115, and the parameter database 117.

In one embodiment, the synthesizing module 205 may be used to generate a transition between two media items corresponding to metadata associated with the current media item, the next media item, or a combination thereof. In addition, the synthesizing module 205 may generate the transition with different synchronization criteria with the two media items. Moreover, the synthesizing module 205 may generate a transition between two media items by combining multiple personalized media items as a synchronized presentation. By way of example, the synthesizing module 205 may determine the first frame of the transition based on either the content information (e.g., thrill, romantic, etc.) associated with the current media item and/or, when applicable, the audio information (e.g., tempo, beats, etc.) associated with the current media item. The synthesizing module 205 may determine the last frame of the transition based on either the content information (e.g., thrill, romantic, etc.) associated with the next media item and/or, when applicable, the audio information (e.g., tempo, beats, etc.) associated with the next media item.

In one embodiment, the synthesizing module 205 may be used to automatically edit the one or more media segments of the transition based upon one or more user-selected parameter (e.g., tempo, beat, etc.), in order to satisfy user criteria such as mood, style, etc. By way of example, in the case of a music event, the synthesizing module 205 can edit the one or more media segments based on beats per minute (bpm) of the audio portion of the media segment, quality of one or more media segments, quality of the audio portion of the one or more media segments, one or more significant events within the media segments, the duration of the media segments, and so forth. In one embodiment, the synthesizing module 205 may be used to exchange one or more media segments of the music/vocal/visual transition if the one or more segments fail to meet a threshold value associated with one or more parameters, e.g., rhythm, mood, etc.

The vocal module 207 works in conjunction with the synthesizing module 205 to generate vocal transitions. In one embodiment, the vocal module 207 applies speech or singing synthesis technology and algorithms, text-to-speech synthesis, lyrics-to-singing synthesis (e.g., Songify®), etc. to generate vocal transition. In one embodiment, the vocal module 207 converts text of the metadata of the current song/channel and the next song/channel into speech for a virtual DJ to announce the vocal transition including the titles and artists of the songs as follows: “That was Dancing Queen by ABBA, next coming up is channel “Funky 80s” starting with “Sign o' the Times” by Prince”. For longer vocal announcements, information about the songs can be retrieved from, e.g., Wikipedia®, Pandora®, playlist and review website, etc. based on the songs' titles. In one embodiment, the vocal module 207 further coverts the speech into singing voice of a virtual DJ, and synchronizes the synthesized singing with other sound or a preview of the next song to provide a singing or “rapping” presentation. The vocal transition may also include event information, previews, advertisement, etc. that are relevant to the played song and/or the next song.

The visualization module 209 works in conjunction with the synthesizing module 205 to generate visual transitions. In one embodiment, the visualization module 209 visualizes the title, theme, elements, etc. of the current media item/channel (e.g., “Only Time” sung by Enya), the next media item/channel (e.g., “I Dreamed A Dream” sung by Susan Boyle), or a combination thereof, as an image or video for the visual transition. In one embodiment, the visualization module 209 further blends elements from the two song visualization in synchrony with the music. The visual transition may also be incorporated with the vocal transition therein, and rendered at the user device.

In other embodiments, the visual material for the transition is completely synthesized at the user device or partially provided by the media platform 103 or other content providers (e.g., social network sites, advertisers, etc.). There may be information display elements showing the name of the current channel, song, content provider, and album/artist in the visual transition. Further, the visual transition may include UI elements for purchasing a song, controlling channels, and enabling/disabling the “vocal transition” function, etc.

The communication module 211 is used for communication between the media platform 103, the sensor modules 107, the one or more applications, the media items database 113, the context data database 115, and the parameter database 117. The communication module 211 may be used to communicate commands, requests, data, etc. In one embodiment, the communication module 211 is used to download media items and associated context data from the one or more databases to the analysis module 203 and the presentation module 213 in order to begin the process of switching media items based upon other user indicated criteria (e.g., timing, object characteristics, media characteristics, etc.). In another embodiment, the communication module 211 may be used to transmit a plurality of media items captured by a mobile device (e.g., a mobile camera) at an event (e.g., a party) and the context data associated with the media items to the media items database 113 and the context data database 115, respectively. The communication module 211 may also be used in connection with the user interface client 109 to determine an input for selecting media items for presentation, when applicable, and/or causing a presentation and/or playback of the transition in-between two media items on one or more displays.

The presentation module 213 is used for presenting one or more transitions in-between the two media items/channels. The presentation module 213 may also be used in connection with the user interface client 109 to present transitions, when applicable, in-between two media items on one or more displays.

FIG. 2B is a diagram of the components of the user interface client 109, according to one example embodiment of the invention. By way of example, the user interface client 109 includes one or more client side components for generation and/or presentation of personalized transition between two media items. It is contemplated that the functions of these components may be combined in one or more components or performed by other components of equivalent functionality. In this embodiment, the user interface client 109 includes a control logic 231, a communication module 233, and a user interface (UI) module 235.

Similar to the control module 201 of the media platform 103, the control logic 231 oversees the tasks, including tasks performed by the communication module 233, and the user interface (UI) module 235. For example, although the other modules may perform the actual task, the control logic 231 may determine when and how these tasks are preformed or otherwise direct the other modules to perform the task.

Similar to the communication module 211 of the media platform 103, the communication module 233 is used for communication between the media platform 103 and the user interface client 109 of the UEs 101. The communication module 233 may be used to communicate commands, requests, data, etc. More specifically, the communication module 233 is used for communication between the communication module 211 of the media platform 103 and the user interface module 235.

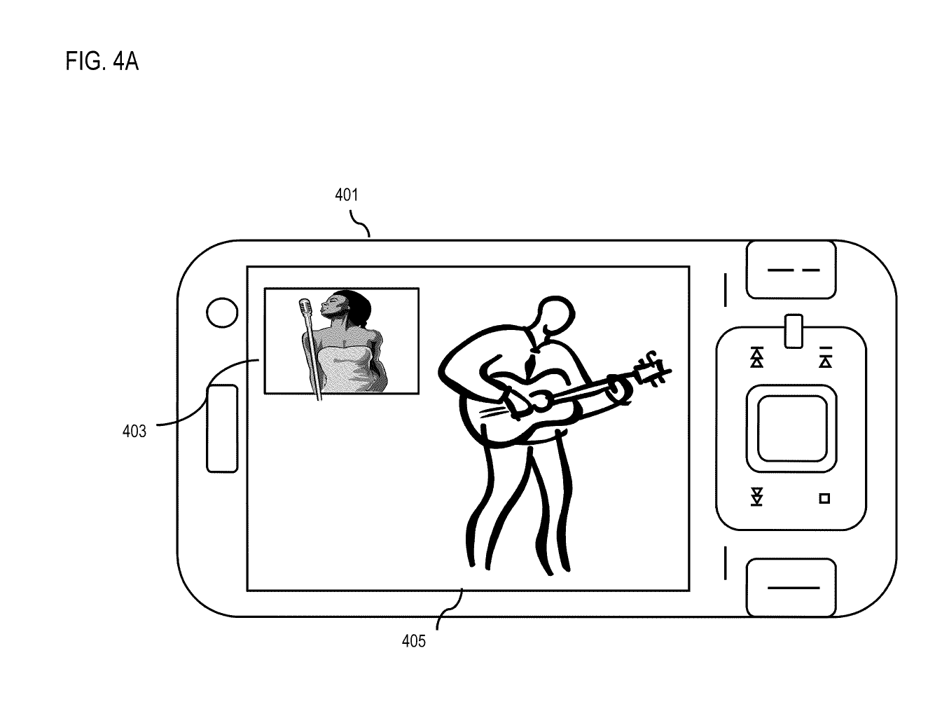

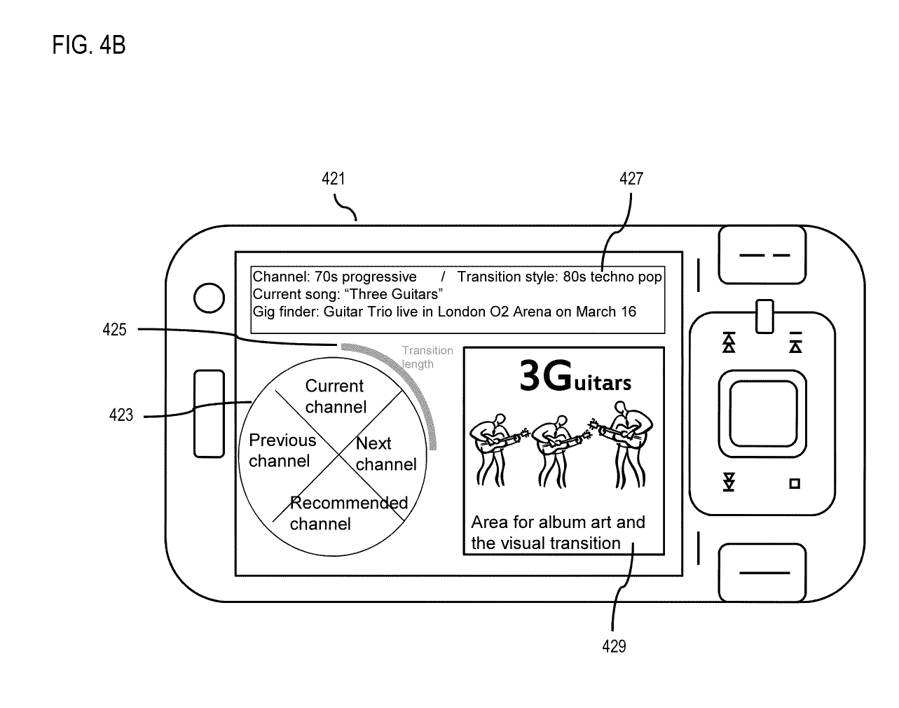

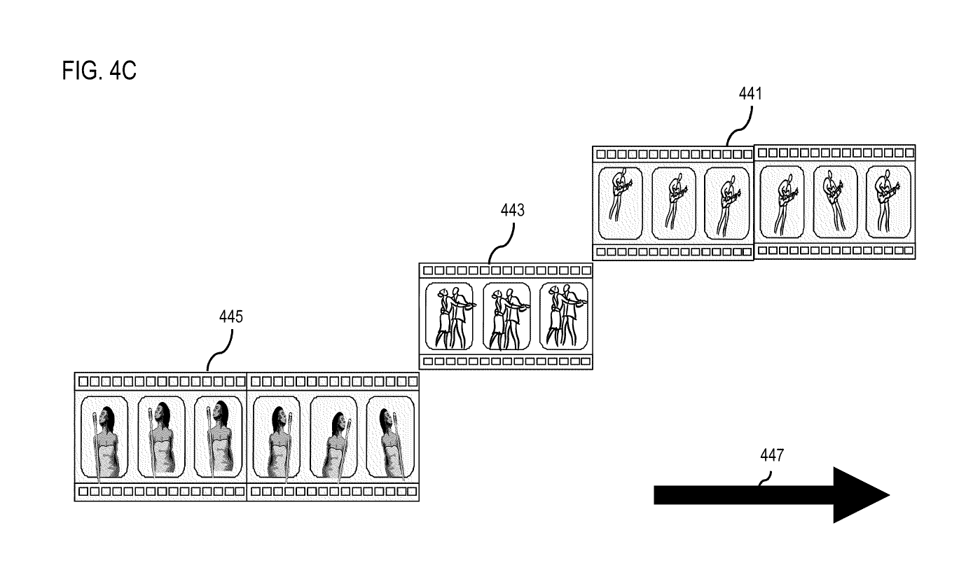

The user interface (UI) module 235 interacts with the media platform 103 in a client-server relationship to cause a rendering of a user interface for presenting the transition in-between two media items. More specifically, in one embodiment, the user interface module 235 may be used to render a user interface that includes one or more selectable user interface elements representing transition styles, moods, etc. and respective transition parameters (e.g., timing length, tempo, beats, etc.), to generate one or more personalized transitions between two media items, and to present and/or playback the one or more personalized transitions between two media items in which style and/or mood. In one embodiment, the user interface module renders the user interface elements relative to the media items as well as information of the characteristics associated with the media items. The characteristics associated with the media items, may include title, genre, artist, sudden changes of sound/lighting volumes (e.g., climax of the music, etc.), time of day, season, orientation, depth of field, white balance, author(s), etc. Illustrative examples of a two-dimensional user interface rendered by the user interface module 235 are shown in FIGS. 4A-4C.

In another example embodiment, when the user interface module 235 determines that the display screen associated with the UEs 101 consists of a three-dimensional display, the user interface module 235 may be used to enable a user to orient and/or move a user interface in three-dimensions to view different media items, personalized transition between two media items, or a combination thereof. By way of example, the user interface module 235 may be used to render a user interface consisting of a personalized transition between two media items consisting of a screen of a 2D representation and a screen of 3D representation of the transition.

The implementation has a service component and a client component. In different implementations (depending also on the user's subscription to the system 100), the service may have a greater role in generating the transitions that are sent to the client that presents them. In other implementations (especially the “offline listening” mode), the client may have a greater role in gathering the material for the transitions and rendering them for presentation.

One implementation is that the musical and vocal transitions are created on the service and mixed into the streamed audio from the channels. Event/activity information is provided by the service for the synthesized vocal transitions.

An alternative implementation for “offline listening” is that the musical transitions are rendered on the client device by manipulating audio content from the first and second songs. Some parts of the musical transition, such as drum beats, may be synthesized by the client through generated MIDI data played through a software synthesizer. Vocal transitions may be created on the client if the speech synthesis software is available on the client.

The visual transitions may be rendered in both implementations by the client. The visual material for the transitions may be completely synthesized or partially provided to the UI client 109 by the media platform 103. Event/activity information may be provided by media platform 103 and/or one or more other service platforms.

In another embodiment, the media platform 103, the media items database 113 and/or the context data database 115 may be embodied at the UE 101, such that one or more hardware and/or software modules and/or elements of the UE 101 perform the functions associated with the media platform 103, the media items database 113 and/or the context data database 115. For instance, the functions of the media platform 103 may be performed by the UI client 109 and the information included within the media items database 113 and/or the context data database 115 may be stored at a local memory within the UE 101. In one embodiment, the functions associated with the media platform 103 may be embodied in one or more services on an external service platform, or be a standalone element of the system 100, and the UE 101 may communicate with the media platform 103 over the communication network 105. Thus, the functions of the media platform 103 may be performed at the UE 101 or at one or more elements of the system 100.

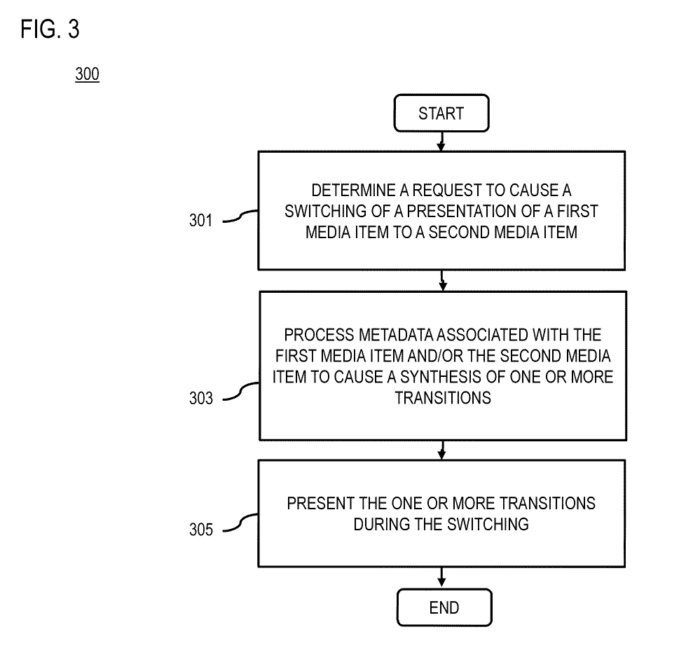

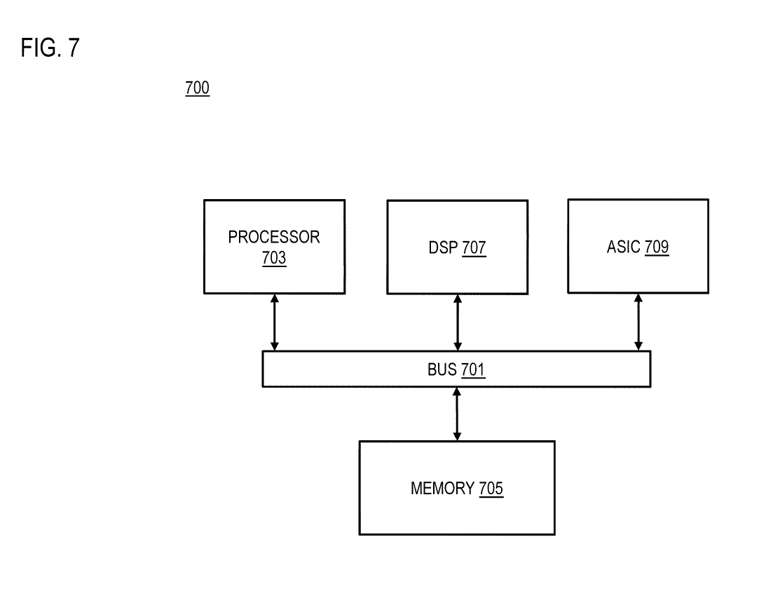

FIG. 3 is a flowchart of a process for switching between presentations of two media items, according to one embodiment. In one embodiment, the media platform 103 performs the process 300 and is implemented in, for instance, a chip set including a processor and a memory as shown in FIG. 7. In step 301, the media platform 103 determines a request to cause, at least in part, a switching of a presentation of a first media item (e.g., video, audio, images, etc.) to a second media item (e.g., video, audio, images, etc.).

In step 303, the media platform 103 processes and/or facilitates a processing of metadata associated with the first media item, the second media item, or a combination thereof to cause, at least in part, a synthesis of one or more transitions. Metadata may be uploaded along with the media items. The synthesis may be based, at least in part, on the timing information, media quality information, one or more audio cues, one or more visual cues, or a combination thereof associated with the media items, the transition, or a combination thereof. The metadata includes time stamps, author, user (client device) location information, tempo, beat, bar, key, rhythm, pitch chords, the dominant melody and bass line, event, device orientation information, accelerometer information, tilt and altitude information, magnetometer data, altimeter data, zoom level data, focal length data, field of view data, range sensor data, or a combination thereof, etc.

In one embodiment, the media platform 103 causes, at least in part, an analysis of the first media item, the second media item, or a combination thereof to determine the metadata, wherein the analysis comprises, at least in part, determining of one or more audio characteristics, one or more video characteristics, or a combination thereof.

By way of example, the media platform 103 analyzes or detects beats (musical tempo and the exact occurrence of onsets), harmony, musical key, dominant melody, and bass line, to synthesize a transition (e.g., a drum loop). These analyses can be performed offline in the user device, and the analysis results can be stored as metadata along with the media items. The metadata is accessed when the transition is generated.

Offline music analysis can be implemented by a server. When implemented, the server analyzes all its music videos or music tracks (e.g. tempo, beats, downbeats, the dominant bass and melody line, chords, key, information about repetitions in a song, the location of the chorus part, etc.) and stores the information in a metadata field of the music video or music track, or otherwise associates the metadata with the media item.

In another example, the tempo, musical key, melody and bass line, and first and last chord of a song are declared by the producer or distributor of the music video. The media platform 103 extracts metadata embedded in the web feed or a file (e.g., a MP3 file).

The one or more transitions include, at least in part, one or more musical transitions, one or more vocal transitions, one or more visual transitions, or a combination thereof. In one embodiment, the client software on the user devices for recording the media items may contain low resolution video for live services to accommodate bandwidth and processing restrictions. For example, the media items can be streamed from the media platform 103 and/or sent as a file, e.g., in Moving Picture Experts Group (MPEG) formats (e.g., MPEG-2 Audio Layer III (MP3)), Windows® media formats (e.g., Windows® Media Video (WMV)), Audio Video Interleave (AVI) format, as well as new and/or proprietary formats.

In one embodiment, the media platform 103 generates a musical transition in-between two songs by analyzing the tempos, chords, the dominant melody and/or bass line of the two songs. The media platform 103 then generates a musical pattern that starts with the tempo of the first song, and then has a subtle tempo change such that it ends with the tempo of the second song. The tempo change can be implemented, e.g., using audio time-scale modification. The generated musical transition can be, e.g., 10 to 20 seconds long (e.g., as defined by the user). The generated musical transition may have some percussion, and some melodic lines or chords, to be aesthetically pleasing. Such an aesthetically pleasing transition can be created between musical materials in two keys with a chord (or sequence of chords) that are related to the two keys, i.e., modulation. For instance, an aesthetically pleasing solution to change key from C minor to Ab major is to play a G major chord in between. These musical solutions can be easily defined as software instructions. By way of example, the transition is created from the last chord of the first song to the first chord of the second song, and the output is a continuous mix of the first song, the generated transition, and the second song.

In another embodiment, a music transition is generated based, at least in part, upon a person's heart rate. The media platform 103 measures a person's heart rate, and then uses the measured heart rate as an input to generate the music transition. Consequently, the music transition is generated during a physical activity of the user that changes with the activity level of the user. The history of the heart rate may also be used as an input parameter for generating the music transition. In another embodiment, a pattern of the music transition is generated depending upon a type of sport of the user.

The media platform 103 may estimate keys of music items by, for example, automatic transcription of melody, bass line, and chords in polyphonic music. The musical material is then rendered into sound with a software synthesizer running on the server. The music transitions can be defined with MIDI or some other symbolic music format. By way of example, the media platform 103 uses MIDI to synthesize a drum loop as a music transition. In addition to through algorithms (e.g., software synthesis), recordings of actual instruments and generic musical phrases may be used to generate sounds.

In another embodiment, the media platform 103 creates the music transition by specifically sampling parts of the first song and the second song, and manipulates these samples in tempo, rhythm and pitch through established digital signal processing (DSP) methods (e.g., speech signal processing, time scale modification, pitch shifting, etc.).

In another embodiment, the media platform 103 adds effects such as low-pass filtering, delay, reverberation, or a combination thereof in the transition. These effects can be implemented using software instructions.

In another embodiment, the media platform 103 generates event/activity announcements by a speech or vocal (singing) synthesizer, or obtains the announcements from an advertisement recording. The announcements may be mixed with the music on a service or at the user device using technology such as the Songify®.

In step 305, the media platform 103 causes, at least in part, a presentation of the one or more transitions during the switching, for example, at a user device (e.g., a mobile phone, a camcorder, a digital camera, etc.). The presentation of the one or more transitions comprises, at least in part, performing a time alignment, a mixing, or a combination thereof among the first media item, the one or more transitions, the second media item, or a combination thereof. By way of example, the media platform 103 cross-fades between a current media item and a synthesized drum loop.

The time alignment may consider one or more synchronization start times, one or more synchronization end times, or a combination thereof for the transition and two media items. The media platform 103 may generate the beginning and the end of the transition in-between two media items based on a different synchronization criterion. It is contemplated that synchronizing the personalized transition between two media items in this manner will often enable the media platform 103 to present and/or display the transition between two media items (e.g., personalized transition between two media items) in manner pleasant to the user. In another example, a user may determine to stagger the synchronization of transition in-between two media items for dramatic effect.

By way of example, while cross-fading between a current media item and a synthesized drum loop, the media platform 103 requests and downloads information of the properties of the new media item, such as its initial tempo. The media platform 103 estimates how long the synthesized drum loop should be played based upon the metadata of the new media item and/or a portion of the new media item, the downloading capabilities of the user device, the communication bandwidth for downloading the metadata of the new media item and/or downloading the portion of the new media item, the communication network traffic, a size of data of the new media item/stream that has to be buffered on the user device before playback, etc., or a combination thereof. By way of example, the media platform 103 plays the synthesized drum loop for two minutes due to a temporary network congestion. One or two musical bars before playing the new media item, the media platform 103 starts synthesizing another drum loop to a tempo and rhythm that matches the beginning of the new media item, and then cross-fades between the other drum loop and the second media item.

The media platform 103 may present and/or playback each of the media items on a different display screen and/or present and/or playback the media items on a single display screen. In either instance, the media platform 103 is able to generate a desired and/or seamless transition for switching the media items.

In another embodiment, when the display screen and/or user interface (UI) for the transition between two media items consists of a three-dimensional display, the media platform 103 may be used to enable a user to orient and/or move the UI in three-dimensions to view one or more media channels. By way of example, the media platform 103 may be used to render a user interface consisting of a cube for a transition between two media items, or an object determined by a user based on the same concept of associating one or more user interface elements.

In one embodiment, the media platform 103 determines at least one transition point (e.g., a predetermined volume, a predetermined chord, etc.) in the first media item based, at least in part, on the request, wherein the synthesis of the one or more transitions is further based, at least in part, on the transition point.

In one embodiment, the media platform 103 determines at least one style (e.g., aggressive) for the one or more transitions based, at least in part, on the metadata, user preference information, contextual information associated with at least one device associated with the presentation, or a combination thereof. For example, an “aggressive style” would generate transitions with dense snare drum beats and distorted guitar sounds. As another example, an 80's style would generate transitions using synthetic instrument sounds that were popular in the 80's. The user may define a new style based upon desired timing, duration, tempo, beat, bar, key, rhythm, pitch chords, and/or the dominant melody and bass line, instrumentation, etc. of the transition.

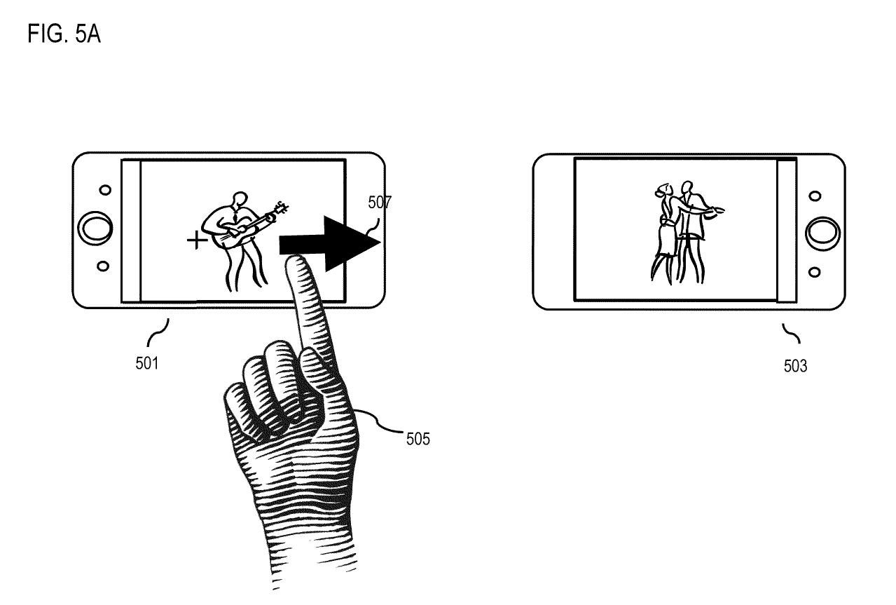

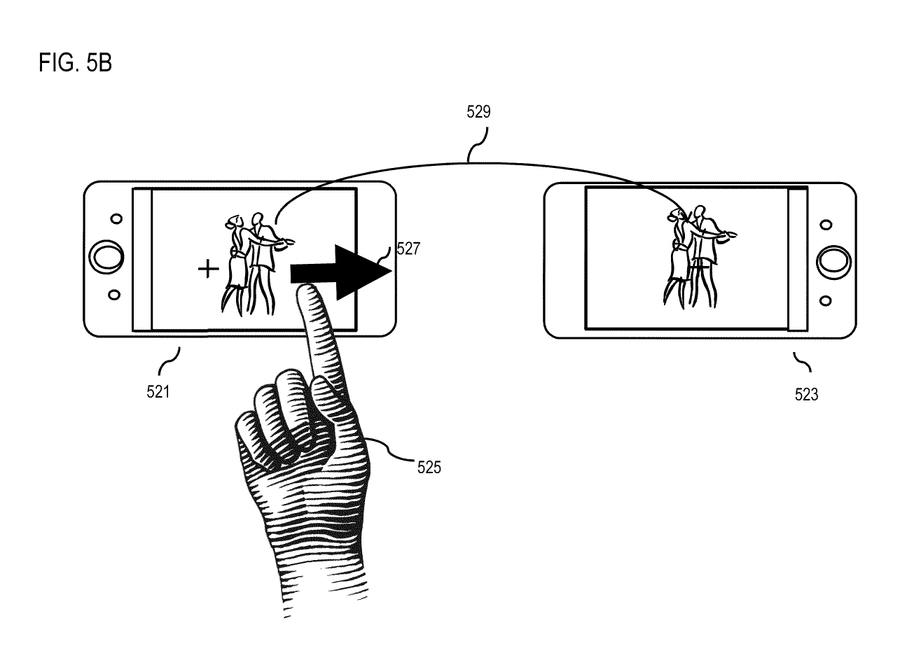

In one embodiment, the first media item is presented at a first device and the second media item is presented at a second device. The media platform 103 determines an input from the first device to initiate the switching of a control of the presentation of the first media item, the second media item, the one or more transitions, or combination thereof to the second device. In one embodiment, the one or more transitions include, at least in part, a spatial transition between the first device and the second device. The details of the switching in-between two devices are discussed in conjunction with FIGS. 5A-5B.

In one embodiment, the media platform 103 processes and/or facilitates a processing of contextual information associated with one or more playback devices, one or more users associated with the one or more playback devices, or a combination thereof to determine mood information. The one or more transitions are further based, at least in part, on the mood information. “Mood” is a parameter used to select the next media item/channel for the user. By way of example, the user has defined his current mood as e.g., “aggressive,” so that the media platform 103 selects only songs or channels that match this mood. The new media item/channel could be selected based on user's mood, or the user's mood could be detected based, at least in part, on the next media item/channel selected by the user.

FIGS. 4A-4C are diagrams of a user interface utilized in the process of FIG. 3, according to various example embodiments. As shown, the example user interface of FIG. 4A includes one or more user interface elements, such as the media items, and/or transitions resulting from the process 300 described with respect to FIG. 3. More specifically, FIG. 4A illustrates a user interface (e.g., interface 401) for requesting a transition between two media items of an event (e.g., a party) on a single two-dimensional screen. As previously discussed, the interface 401 is generated by the media platform 103 associated with the event. As shown in FIG. 4A, a user is able to touch or select a preview screen 403 within a main screen 405 to switch from a guitarist video to a singer video via one-touch. The preview may contain only one image (e.g., a thumbnail) or a short video clip of the singer video.

FIG. 4B illustrates another user interface (e.g., interface 421) for requesting a transition between two media items/channels. FIG. 4B also shows a controller that allows the user to swap between the media items/channels. This controller is modeled from an old-fashion radio frequency dialer 423 with four quadrants of a previous channel, a current channel, a next channel and a recommended channel. In one embodiment, the user may swap channels by turning the circular dialer 423. In another embodiment, the user may obtain previews of different channels by turning the dialer 423 (while no transition is generated yet). The preview may be implemented by the system 100 so that it relays the same content it is currently streaming to another user listening to this channel. Releasing the dialer 423 triggers the transition and returns the dialer 423 to face north, and then it is showing the new channel.

There are many other interfaces and functionalities for swapping channels. For example, if the device had a flexible form (such as the kinetic device prototype by Nokia®), the user device could be bended or twisted to swap the channels.

The interface 421 can also provide means for the user to define a desired length and style of the transition. The user may define the duration of the transition, for example, by drawing an arc graphic next to the dialer 423 (the transition for a full circle could be e.g. 60 seconds). An arc 425 around the channel dialer 423 has a length defined through a two-finger input to determine a desired length of the transition (e.g., a quarter of the circle equal to 15 seconds). This transition length so set may be overridden with a length indicated by a drag gesture for channel swapping. The style of the transition can be shown in the user interface skin of the client. The theme can be changed through the dialer 423.

In addition, an information display element/box 427 shows the name of the current channel (e.g., 70s progressive), transition style (e.g. 80s techno pop), current song (e.g., “Three Guitars”), and concert/event/ad information related to the current song or artist (e.g., Guitar Trio live in London O2 Arena on March 16). The information displayed may contain text, animated text, still images, video images, interactive elements (such as games), etc.

Within the interface 421, the user can touch an area 429 for album art and the visual transition to generate a visual transition via one-touch. In another embodiment, a touch of the area 429 opens up a new screen for viewing album art or other visualization option, and generating the visual transition accordingly. Further, there may be UI elements for purchasing a song, controlling one's own channel, enabling/disabling the “vocal transition,” etc. (not shown).

In addition, a user has the option to automatic or manual synchronization of the media items and the transition between two media items. An interface shown in FIG. 4C shows a guitarist video 441, the transition of a dance video 443, and a singer video 445 aligned back-to-back. The user can manually adjust the synchronization by moving along a timeline 447 so they have some overlap or blank in-between.

In one embodiment, the user can click on a channel in a list presented on a user interface to activate a generation of a transition. In one embodiment, the user drag-and-drop a channel “tile” on top of another to activate a generation of a transition between two channels. The distance between fingers in the drag-and-drop gesture could control the length of transition. Alternatively, the amount of overlap between the drag-and-dropped channel “tile” and the other channel “tile” controls the length of the transition.

In one embodiment, the user can select between a normal transition or a preview of a transition through touch hover sensing. By way of example, the user clicks on a new channel to select a normal transition, while the user select the new channel by hovering brings about a preview of the transition.

In one embodiment, the user can control mix with hover sensing on top of two channels (songs). By way of example, the song which is pressed more is more audible. In another example, only the song pressed more is audible. In one embodiment, when the finger is closer to the display of the second song, the second becomes audible through a cross fade, or beat synchronous mix without crossfade, or beat segment mix without crossfade.

In one embodiment, the user can extend the transition beyond the predefined duration by manually rotating the channel selection dialer. When the user stops rotating the dialer, a preview of the transition is generated, and the original version of the song is played thereafter. In another embodiment, the amount of manual rotation of the dialer increases the complexity of the transition mix. In some embodiments, the aggressiveness of pressing or turning the channel dialer controls the length of transition, or defines the transition style or the user's mood.

Based on user's music profile, the system 100 selects suitable songs from different matching channels and generates a seamless mix between the preview clips. During the preview of each channel, the system 100 shows the name of the current previewed channel and allows the user to select which channel to listen to.

In some example embodiments, the user interface can be three-dimensional, wherein the media channels can be presented as cubes or blocks and the whole user interface with its elements can be rotated over the three axis. In some example embodiments, the two-dimensional user interface can be overlaid on a map presentation.

FIG. 5A shows a musical transition generated between a music video currently played in a first user device and a music video to be played in a second user device, according to one embodiment. In one embodiment, an interface is provided for the users to collaboratively create a transition of songs on a playlist, in a party setting, where there are multiple devices present. By way of example, each of the first user device 501 and the second user device 503 are wirelessly connected to a server at the party to play the musical videos at one time. The user of the first user device 501 may give the turn to be the “DJ of the party” to a second user by flicking his device with his finger 505 in the direction 507 of the second user device 503.

In another embodiment, the first user turns a near field communication (NFC) end of the first user device towards the second user device to inform the second user device to take over from then on, and then the second user device can communicate with the server about the switch of control and the generation of a transition. In yet another embodiment, the first user calls out a screen showing all the user devices wirelessly connected to the server, and then selects the second user device by touching a representation of the second device there on.

By way of example, while the first user device is playing the playlist chosen by the first user, the first user device is wirelessly connected to external loudspeakers that play the music during the party. During the playback of a first music video, the first user makes a flicking gesture on the first user device in the direction of the second user device to indicate that he wants to give the turn for “DJ'ing” to the second user.

The two user devices generate in synchrony a transition between the music video playing on the first user device and the music video that is the first one in the playlist of the second user. The transition between the two user devices can be played on the external loudspeakers, or only on the user devices while the external loudspeakers are mute. In one embodiment, the first music video of a guitarist is played in the first user device, the transition made of a dancing video is played in gradually increasing volume on the second user device (and correspondingly decreasing volume on the first user device). Until the transition has ended and the normal playback of the music video of a singer is played on the second user device. The second user device may connect to the external loudspeakers and to play the transition of dancers or the music video of a singer.

In another embodiment, the first music video of a guitarist and the transition made of a dancing video are played in the first user device. The transition made of a dancing video is played in gradually decreasing volume on the first user device and correspondingly increasing volume on the second user device that plays the music video of a singer. The second user device may connect to the external loudspeakers and to play the music video of a singer. On the second user device, the transition made of a dancing video may indicate the first user or the spatial direction of the first user device.

In yet another embodiment, the first music video of a guitarist is played in the first user device. The transition made of a dancing video is played in the first user device and then the second user device in a spatial manner. FIG. 5B shows a spatial transition generated between a music video currently played in a first user device and a music video to be played in a second user device, according to one embodiment. In addition to generating a musical video transition between the music video in the first user device 521 and the music video in the second user device 523, a spatial transition is presented for the transition of the music video playback between the devices by showing the transition made of a dancing video as if moving from the first user device to the second user device. The user of the first user device 521 may trigger the spatial transition by flicking his device with his finger 525 in the direction 527 of the second user device 523. As a result, the transition made of a dancing video appears to be moving from the first user device 521 to the second user device 523 along a trajectory line 529.

In another embodiment, the volume level of the sound at the second user device increases while the volume of the sound fades out at the first user device, producing the sound effects that the movement of the transition video between the devices via the space like an object is moving from the first user device to the second user device. When the transition video is virtually arrived at the second user device, the sound representing the object is played only by the second user device. The movement may include a horizontal movement, a vertical movement, or a combination thereof.

The example embodiments generate one or more musical, vocal and/or visual transitions when switching between media items, channels/pages, etc. The transitions may be based on a style selected by a user, the content of the media items currently played on the same channel or two different channels, etc. A musical transition may be done by analyzing the audio content of the current media item and pre-accessing the audio content in the next media item for generating a transition in-between. A vocal transition may be done via speech or singing synthesis technology. A visual transition may be done by mixing the visual elements of the media items, and/or visualizing the audio contents of the media items. The example embodiments thus provide personalized and/or user-controlled transitions for media items swapping.

The processes described herein for switching between presentations of two media items may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

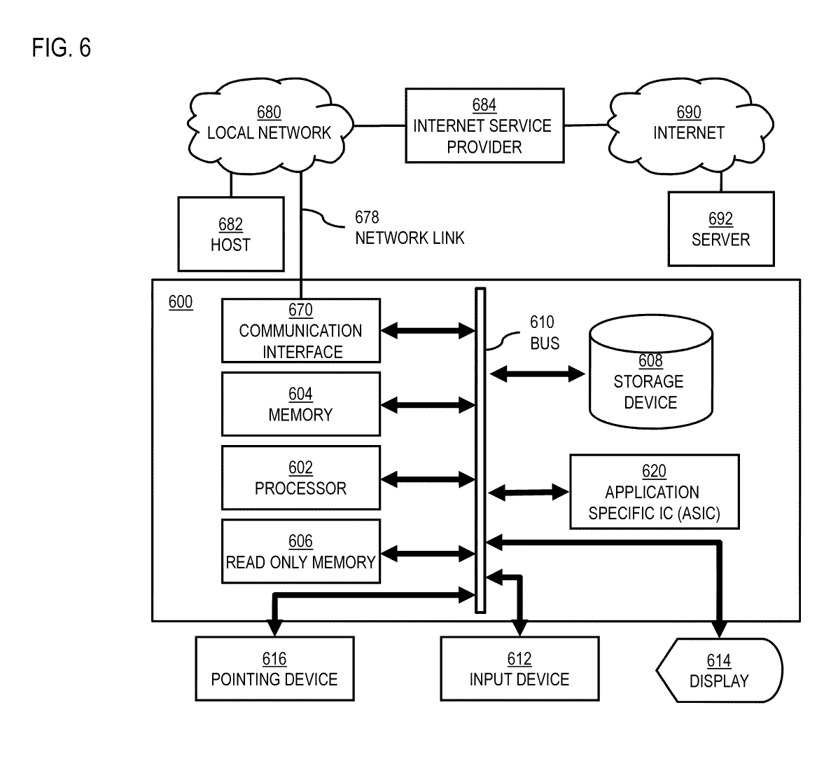

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to switch between presentations of two media items as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of switching between presentations of two media items.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to switch between presentations of two media items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for switching between presentations of two media items. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for switching between presentations of two media items, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection from the UE 101 to the communication network 105 for switching between presentations of two media items.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to switch between presentations of two media items as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of switching between presentations of two media items.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to switch between presentations of two media items. The memory 705 also stores the data associated with or generated by the execution of the inventive steps.

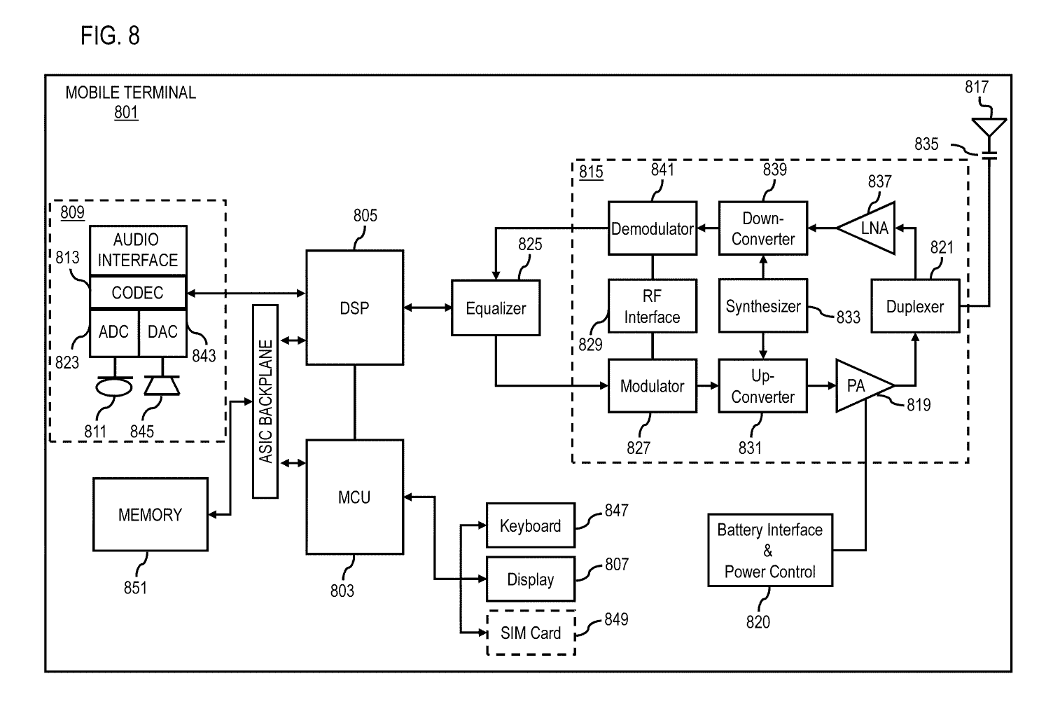

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of switching between presentations of two media items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of switching between presentations of two media items. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to switch between presentations of two media items. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a request to cause, at least in part, a switching of a presentation of a first media item to a second media item;
a processing of metadata associated with the first media item, the second media item, or a combination thereof to cause, at least in part, a synthesis of one or more transitions; and
a presentation of the one or more transitions during the switching.

2. A method of claim 1, wherein the one or more transitions include, at least in part, one or more musical transitions, one or more vocal transitions, one or more visual transitions, or a combination thereof.

3. A method of claim 1, wherein the (1) data and/or (2) information and/or (3) at least one signal are further based, at least in part, on the following:
at least one determination of at least one transition point in the first media item based, at least in part, on the request,
wherein the synthesis of the one or more transitions is further based, at least in part, on the transition point.

4. A method of claim 1, wherein the (1) data and/or (2) information and/or (3) at least one signal are further based, at least in part, on the following:
at least one determination of at least one style for the one or more transitions based, at least in part, on the metadata, user preference information, contextual information associated with at least one device associated with the presentation, or a combination thereof

5. A method of claim 2, wherein the (1) data and/or (2) information and/or (3) at least one signal are further based, at least in part, on the following:
an analysis of the first media item, the second media item, or a combination thereof to determine the metadata.

6. A method of claim 5, wherein the analysis comprises, at least in part, determining of one or more audio characteristics, one or more video characteristics, or a combination thereof.

7. A method of claim 1, wherein the presentation of the one or more transitions comprises, at least in part, performing a time alignment, a mixing, or a combination thereof among the first media item, the one or more transitions, the second media item, or a combination thereof.

8. A method of claim 1, wherein the first media item is presented at a first device and the second media item is presented at a second device, and wherein the (1) data and/or (2) information and/or (3) at least one signal are further based, at least in part, on the following:
an input from the first device to initiate the switching of a control of the presentation of the first media item, the second media item, the one or more transitions, or combination thereof to the second device.

9. A method of claim 8, wherein the one or more transitions include, at least in part, a spatial transition between the first device and the second device.

10. A method of claim 1, wherein the (1) data and/or (2) information and/or (3) at least one signal are further based, at least in part, on the following:
a processing of contextual information associated with one or more playback devices, one or more users associated with the one or more playback devices, or a combination thereof to determine mood information,
wherein the one or more transitions are further based, at least in part, on the mood information.

11. An apparatus comprising:
at least one processor; and
at least one memory including computer program code for one or more programs,
the at least one memory and the computer program code configured to, with the at least one processor, cause the apparatus to perform at least the following,
determine a request to cause, at least in part, a switching of a presentation of a first media item to a second media item;
process and/or facilitate a processing of metadata associated with the first media item, the second media item, or a combination thereof to cause, at least in part, a synthesis of one or more transitions; and
cause, at least in part, a presentation of the one or more transitions during the switching.

12. An apparatus of claim 11, wherein the one or more transitions include, at least in part, one or more musical transitions, one or more vocal transitions, one or more visual transitions, or a combination thereof.

13. An apparatus of claim 11, wherein the apparatus is further caused to:
determine at least one transition point in the first media item based, at least in part, on the request,
wherein the synthesis of the one or more transitions is further based, at least in part, on the transition point.

14. An apparatus of claim 11, wherein the apparatus is further caused to:
determine at least one style for the one or more transitions based, at least in part, on the metadata, user preference information, contextual information associated with at least one device associated with the presentation, or a combination thereof.

15. An apparatus of claim 12, wherein the apparatus is further caused to:
cause, at least in part, an analysis of the first media item, the second media item, or a combination thereof to determine the metadata.

16. An apparatus of claim 15, wherein the analysis comprises, at least in part, determining of one or more audio characteristics, one or more video characteristics, or a combination thereof.

17. An apparatus of claim 11, wherein the presentation of the one or more transitions comprises, at least in part, performing a time alignment, a mixing, or a combination thereof among the first media item, the one or more transitions, the second media item, or a combination thereof.

18. An apparatus of claim 11, wherein the first media item is presented at a first device and the second media item is presented at a second device, and wherein the apparatus is further caused to:
determine an input from the first device to initiate the switching of a control of the presentation of the first media item, the second media item, the one or more transitions, or combination thereof to the second device.

19. An apparatus of claim 18, wherein the one or more transitions include, at least in part, a spatial transition between the first device and the second device.

20. An apparatus of claim 11, wherein the apparatus is further caused to:
process and/or facilitate a processing of contextual information associated with one or more playback devices, one or more users associated with the one or more playback devices, or a combination thereof to determine mood information,
wherein the one or more transitions are further based, at least in part, on the mood information.

21-48. (canceled)
